(19) United States
(12) Patent Application Publication
(10) Pub. No.: US 2018/0341922 A1
(43) Pub. Date: Nov. 29, 2018

(54) Master Calendar for Vacation Rental Bookings

(71) Applicant: Jill Monet Mason, Leavenworth, WA (US)

(72) Inventor: Jill Monet Mason, Leavenworth, WA (US)

(21) Appl. No.: 15/607,473

(22) Filed: May 27, 2017

(51) Int. Cl. G06Q 10/10; G06Q 50/12; G06Q 10/02

(52) U.S. Cl. CPC G06Q 10/109; G06Q 10/02; G06Q 50/12

(57) ABSTRACT

A master calendar displaying booking dates from one or more vacation rental properties created by importing each property's data through web URLs.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENT TO SEQUENCE LISTING, A TABLE, OR A COMPUTER PROGRAM LISTING COMACT DISC APPENDIX

Not Applicable

### BACKGROUND OF THE INVENTION

With the advent of the Home Vacation Rental industry and Home Exchange (i.e. AirBnB, VRBO) there is a new area of businesses that exist to serve the needs of these rental homes. They comprise of (but are not limited to): Cleaners, Hot Tub Servicers, Plowing, Landscaping, Maintenance Services. These businesses schedule their services with respect to the booking dates: Check IN, Check Out, Mid Stay, Mid Vacancy, and while Vacant, and on a set schedule. Each company services anywhere from 1 to over 100 properties.

After talking to many of these businesses (at least 12) everyone uses the same process as follows. They gather each property's booking data from the owner or Property manager via a variety of methods including (but not limited to) email, text messages phone calls, and then transfer each property's booking dates to a paper calendar or spreadsheet where they then create their own task schedules.

I also manage my own Vacation Rental, which I list on both Airbnb and VRBO. I found the task of gathering my booking data through both sites, and keeping my Hot Tub Servicer and Cleaning Servicer notified of the current booking calendar to be both time consuming and prone to error.

### BRIEF SUMMARY OF THE INVENTION

The invention is a web based application developed to import booking data from one or more vacation rental property's available feeds and combine the booking information into one global calendar. The object of the invention is to provide owners, property managers and/or service providers booking information in order to perform their respective jobs relating to each booking's Check In and Check Out dates.

Additional objects of the invention are that the booking dates per property can also be used to notify service providers, generate tasks lists, create employee schedules and provide reports.

There are two websites (owned by the inventor) currently using the invention. For Owners and Managers, a web application providing a way to forward booking dates for one or more properties on a set schedule to service providers: https://www.vrmastercalendar.com. For Service Providers, a web application providing a way to gather booking data from all owners and property managers' properties they service, generate tasks based on these bookings, and create employee schedules: https://www.vrscheduler.com.

### BRIEF DESCRIPTION OF DRAWINGS

FIG. 1 is the flow of data from when bookings occur, moving the booking data from AirBnb, VRBO and other booking engines into the database, and then displaying all data onto the master calendar.

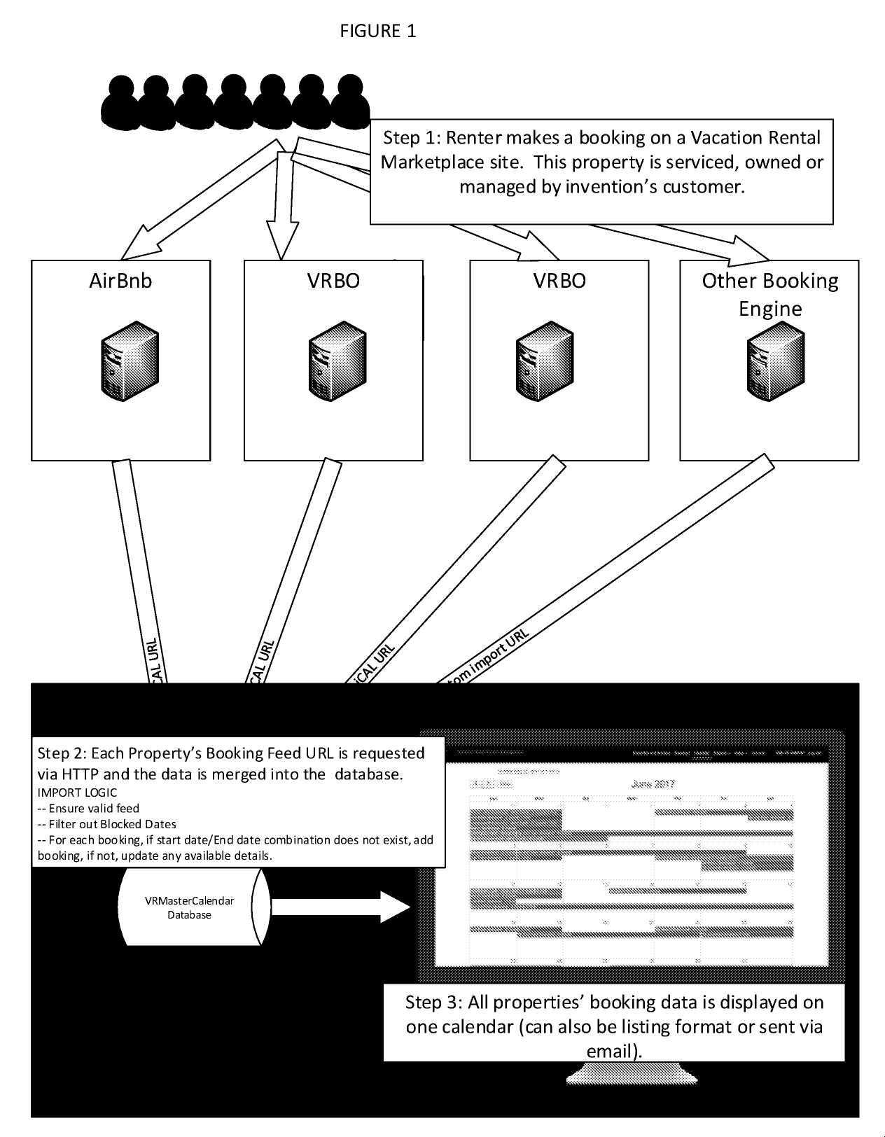

### DETAILED DESCRIPTION OF THE INVENTION

A Customer is someone who would use the invention. This could be a property manager, a service provider individual, a service provider company, or an owner. A Vacation Rental Property (also referred to as: property) is a home, apartment or other accommodation that is rented on a short-term basis. Booking information includes a minimum of Check In date and Check Out date for each property.

A Customer or Customer's customers initially set's up each property by entering through a website the name and booking feed URL for each vacation rental property they service. The booking feed URLs can be iCAL URLs (AirBnB and VRBO both provide iCAL URLs), or any other available feed (for example flat file or JSON data) served over HTTP. Each property's booking feed must contain at a minimum check in date and check out date for each booking.

Property booking data is imported every 5 minutes for each property as follows.
The HTTP request is sent to the URL entered during setup
The result is a string which is then checked for validity
   If the string does not contain valid booking data or the service is down, no data is imported
   If the string is valid, and contains booking data, then for each booking
      If the booking is a “blocked dates” booking—no data is imported
      If the booking is a true booking the database is queried to see if this booking is already imported
         If the booking is already imported, any additional details provided are updated
         If the booking is not in the database, the booking is added to the database with the following information: Check In Date, Check Out Date, Property
         If the booking provides guest name or guest counts, those are also imported.

All property data is available for the customer use including (but not limited to):
Viewing all bookings per property on a master calendar
Sharing specified properties' bookings with additional service providers via a web dashboard or email.
Notifying service providers of additional bookings and cancellations that occur
Generate tasks based on Bookings. Here are some examples of tasks that could be generated:
   Create a Cleaning task every check out
   Create an Inspection task every check in
   Create a Mid-Stay hot tub check task every 4 days between check in and check out
   Create a Mid-Vacancy hot tub check task every 14 days if there are no bookings
The customer can then view all the generated tasks on a calendar, and assign tasks to employees in order to create their employee schedules.

1. An online computer program for sharing vacation rental property booking information comprising:
logic to import one or more properties bookings' check in and check out dates from online data feeds and
displaying all properties' booking check in and check out dates onto one online calendar with the
ability to share calendar to property servicers and other individuals requiring property's booking information.
